(19) United States
(12) Patent Application Publication
(10) Pub. No.: US 2013/0005171 A1
(43) Pub. Date: Jan. 3, 2013

(54) CONNECTOR FIXING STRUCTURE

(75) Inventor: Shinichi Igarashi, Yokkaichi-city (JP)

(73) Assignee: SUMITOMO WIRING SYSTEMS, LTD., Mie (JP)

(21) Appl. No.: 13/634,626

(22) PCT Filed: Oct. 18, 2010
(86) PCT No.: PCT/JP2010/068277

§ 371 Date: Sep. 13, 2012

(30) Foreign Application Priority Data
May 17, 2010 (JP) 2010-112745

(51) Int. Cl. H01R 13/62; H01R 13/648

(52) U.S. Cl. 439/345; 439/607.05

(57) ABSTRACT

A connector fixing structure includes a connector provided at one end of an electric wire, a protector surrounding a portion of the electric wire, and a fixing portion integrally formed with the protector and fixating the connector. The protector and the fixing portion are formed of a protection material that includes a base material and a binder material having a melting point lower than that of the base material. The protector and the fixing portion are joined at each joint portion by cooling and solidifying the melted binder material.

### TECHNICAL FIELD

The present invention relates to a fixing structure for a connector used for a wire harness mounted in a vehicle.

### BACKGROUND ART

A technology is conventionally known in which a connector is fixated to a wire harness by wrapping a fixing tape around the connector and the wire harness (e.g., Patent Literature 1).

In addition, a fastener is conventionally known, the fastener having a rubber band, and a female coupling fabric and a male coupling fabric provided at both ends of the rubber band. Furthermore, a technology is also conventionally known to fasten an optional connector to a main wire by wrapping the fastener around the main wire (e.g., Patent Literature 2).

### CITATION LIST

### Patent Literature

Patent Literature 1: Japanese Patent Laid-Open Publication No. 2000-331751

Patent Literature 2: Japanese Patent Laid-Open Publication No. H11-026059

### SUMMARY OF INVENTION

### Technical Problem

In the technologies disclosed in Patent Literatures 1 and 2, fixating a connector to a wire harness requires work to wrap the fixing tape and the fastener. This increases work man-hours in production of wire harnesses and thus leads to an increase in the production cost of wire harnesses.

In view of the circumstance above, an object of the present invention is to provide a connector fixing structure that can successfully retain a connector.

### Solution to Problem

In order to address the circumstance above, a connector fixing structure according to a first aspect includes a connector provided at one end of an electric wire, a protector surrounding a portion of the electric wire, and a fixing portion integrally formed with the protector and fixating the connector. The protector and the fixing portion are formed of a protection material that includes a base material and a binder material having a melting point lower than that of the base material. The protector and the fixing portion are joined at each joint portion by cooling and solidifying the melted binder material.

In the connector fixing structure according to a second aspect, the fixing portion in the connector fixing structure according to the first aspect is provided with a groove adjacent to a boundary between the fixing portion and the protector.

In the connector fixing structure according to a third aspect, the connector in the connector fixing structure according to the first aspect is retained by a retaining hole provided to the fixing portion.

### ADVANTAGEOUS EFFECTS OF INVENTION

In the connector fixing structure according to the first to third aspects, the protector protects a portion of the electric wire. Further, the fixing portion is integrally formed with the protector and fixates the connector provided at the one end of the electric wire. Accordingly, when the connector is fixated by the fixing portion, the electric wire protected by the protector is not routed for unnecessary extension. This minimizes work man-hours associated with wiring of the electric wire and fixation of the connector, thus curtailing the production cost.

In particular, according to the connector fixing structure in the second aspect, the fixing portion is bent along the groove, for example. Alternatively, the fixing portion is cut along the groove to be separated from the protector. Thus, in a case where it is not necessary to fixate the connector, space saving in a vicinity of the protector becomes possible.

In particular, according to the connector fixing structure in the third aspect, the connector can be retained by the retaining hole, a simple structure.

### BRIEF DESCRIPTION OF DRAWINGS

FIG. 1 is a plan view illustrating an exemplary configuration of a wire harness according to an embodiment of the present invention.

FIG. 2 is a perspective view illustrating an exemplary configuration of a fixing structure.

FIG. 3 is another perspective view illustrating the exemplary configuration of the fixing structure.

FIG. 4 is an exploded perspective view illustrating an exemplary configuration of a mold used for molding the fixing structure.

FIG. 5 is a perspective view illustrating an exemplary configuration of a support plate.

FIG. 6 is a front view illustrating an exemplary method of producing the fixing structure.

FIG. 7 is another front view illustrating the exemplary method of producing the fixing structure.

### DESCRIPTION OF EMBODIMENTS

Embodiments of the present invention are described in detail below with reference to the drawings.

<1. Configuration of Wire Harness and Protection Structure>

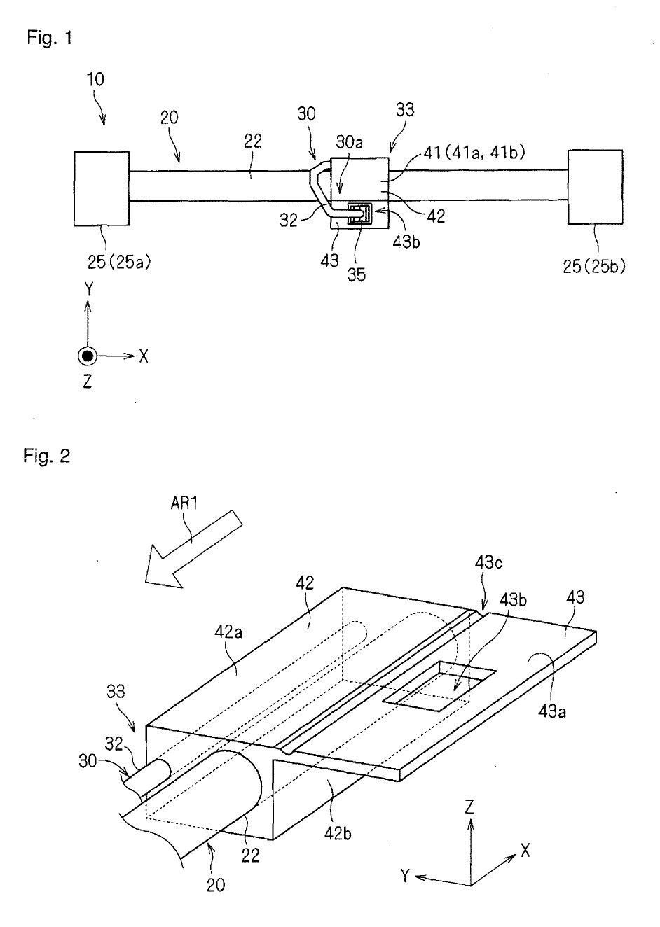

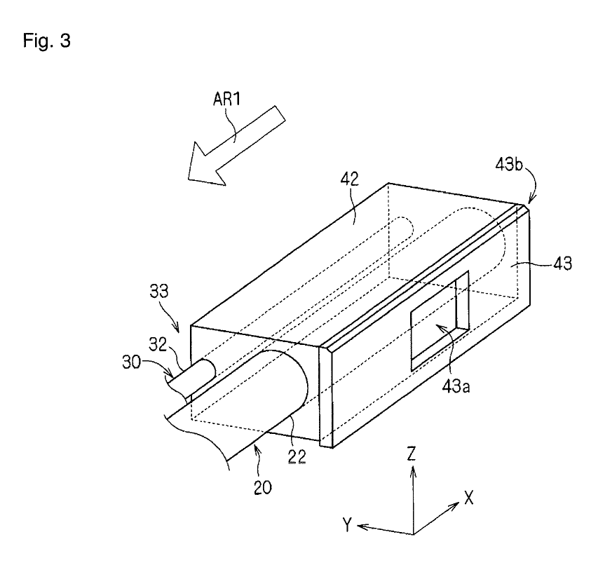

FIG. 1 is a plan view illustrating an exemplary configuration of a wire harness 10 according to an embodiment of the present invention. FIGS. 2 and 3 are perspective views each illustrating an exemplary configuration of a fixing structure 33 for a connector 35. In this embodiment, the wire harness 10 includes a bundle of a plurality of electric wires 22 and at least one electric wire 32, as shown in FIG. 1, and is used for power supply, and transmission and reception of signals. With reference to FIG. 1, the wire harness 10 mainly includes a main wire 20, a branch wire 30, and a fixing structure 33.

In order to clarify a directional relationship of these components, FIG. 1 and the drawings thereafter include, as needed, an XYZ rectangular coordinate system in which a Z-axis direction is a perpendicular direction and an XY plane is a horizontal plane. Furthermore, for convenience of illustration, the connector 35 is omitted in FIG. 2.

The main wire 20 includes the plurality of electric wires 22 and electrically connects connectors 25 (25a and 25b) attached to both ends thereof. The connectors 25 (25a and 25b) at the both ends are then connected to corresponding connectors of electric components (not shown in the drawing).

The branch wire 30 includes, as shown in FIG. 1, at least one electric wire 32 branching from the main wire 20. One end 30a of the branch wire 30 is inserted to the connector 35, as shown in FIG. 1.

The fixing structure 33 fixates the connector 35 to prevent interference between the connector 35 and another component. As shown in FIGS. 1 to 3, the fixing structure 33 mainly includes the connector 35, and a protector 42 and a fixing portion 43, both of which are formed of nonwoven fabrics 41.

The nonwoven fabrics 41 (protection material) each are mainly composed of PET (polyethylene terephthalate: base material) and a binder material formed of a copolymer of PET and PEI (polyethylene isophthalate). More specifically, the nonwoven fabrics 41 each are composed of elementary fibers formed of the base material and shaped into lines and binder fibers formed of the sheath-shaped binder material provided around the elementary fibers.

A melting point of the binder material (second temperature) is 110 to 150° C. and is defined so as to be lower than that of the base material (a melting point of PET: approximately 250° C. (first temperature)).

The connector 35 is an electric component electrically connected to the branch wire 30. As shown in FIG. 1, the connector 35 is provided at the one end 30a of at least one electric wire 32 included in the branch wire 30. In the present embodiment, the connector 35 is connected, for example, to an optionally mounted electric component (not shown in the drawing).

The protector 42 is a block having a substantially rectangular shape (square or rectangle) in a side view. As shown in FIGS. 2 and 3, the protector 42 surrounds a portion of the respective electric wires 22 and 32. Thereby, the portions of the electric wires 22 and 32 surrounded by the protector 42 are successfully protected without interfering with another component.

The fixing portion 43 is a sheet having a substantially rectangular shape (square or rectangle) in a plan view, and is integrally formed with the protector 42. As shown in FIG. 2, a flat surface 43a of the fixing portion 43 and a flat surface 42a of the protector 42 (flat surfaces formed on a Z-axis plus side) are leveled (flush) to each other.

The flat surface 43a of the fixing portion 43 is provided with a retaining hole 43b. The retaining hole 43b is a through hole passing through the fixing portion 43. The connector 35 can be inserted to the retaining hole 43b (see FIG. 1).

Accordingly, the fixing portion 43 can retain the connector 35 with the retaining hole 43b, which is a simple structure. Furthermore, when no optional electric component (not shown in the drawing) associated with the connector 35 is in use and thus the connector 35 is not connected to another connector (not shown in the drawing), the connector 35 is fixated proximate to the main wire 20 (see FIG. 1).

In the present embodiment, the size (area in a plan view) of the retaining hole 43b is defined to be smaller than the size (cross-sectional area in the plan view) of the connector 35 to be inserted. Accordingly, the connector 35 is successfully fixated by the fixing portion 43.

Furthermore, the fixing portion 43 is provided with a groove 43c adjacent to a boundary between the fixing portion 43 and the protector 42. The groove 43c extends, as shown in FIGS. 2 and 3, in a direction of an arrow AR1 (one direction) along the electric wires 22 and 32 protected by the protector 42. Accordingly, with the fixing portion 43 bent at the groove 43c, the fixing portion 43 is compactly folded (see FIG. 3) along one side surface 42b (see FIG. 2). Therefore, it is possible to save space in proximity of the protector 42 when it is not necessary to fixate the connector 35.

<2. Method of Producing Protection Structure>

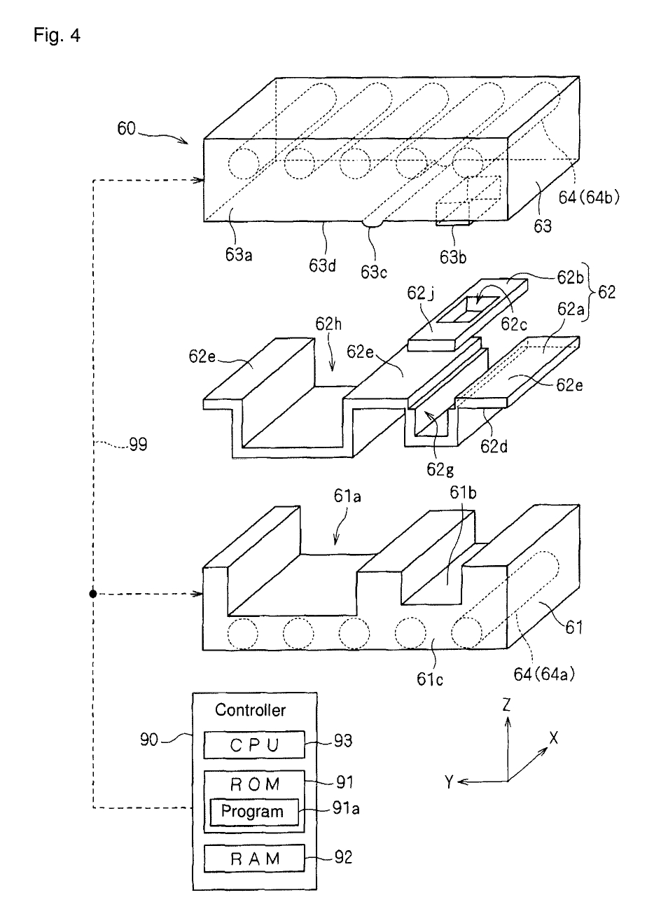

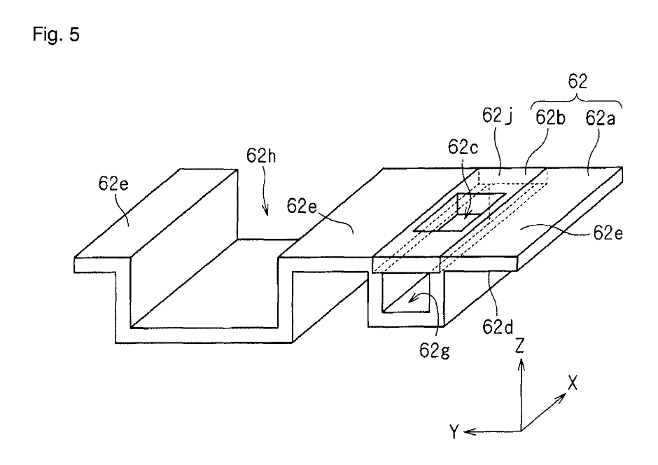

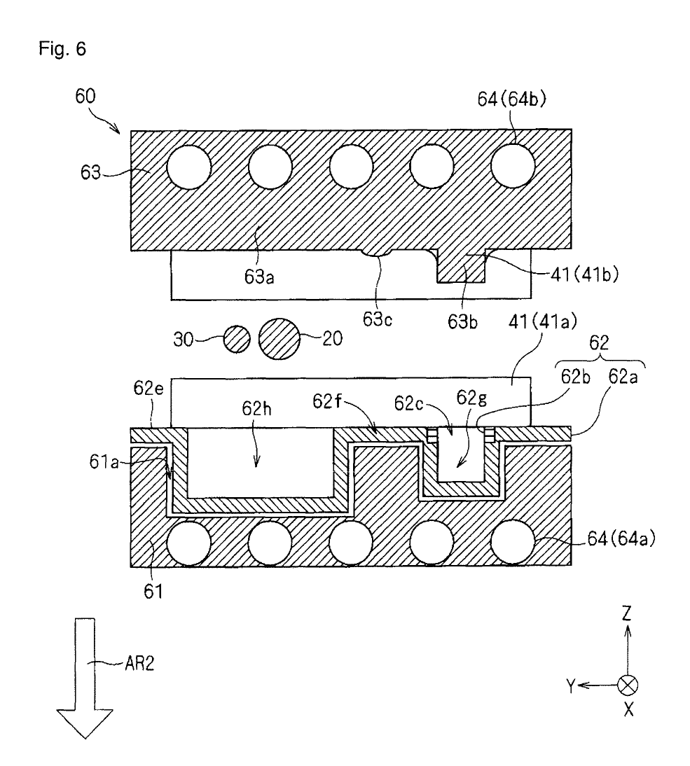

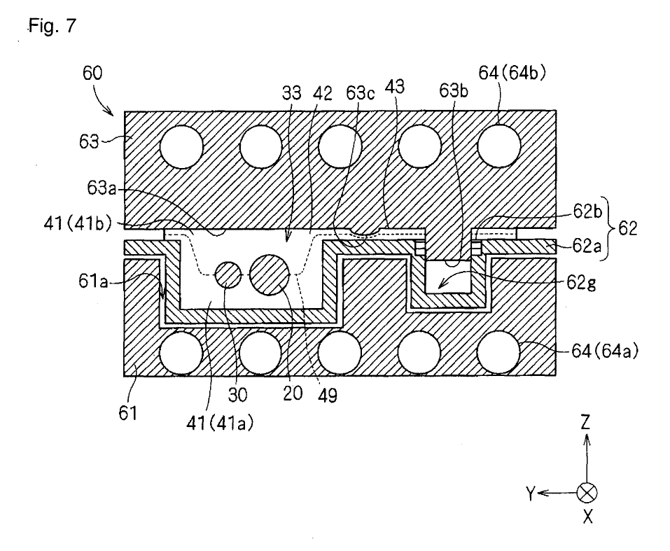

FIG. 4 is a perspective view illustrating an exemplary configuration of a mold 60 used for molding of the fixing structure 33. FIG. 5 is a perspective view illustrating an exemplary configuration of a support plate 62 included in the mold 60. FIGS. 6 and 7 are front views each illustrating an exemplary method of producing the fixing structure 33. In the following, the configuration of the mold 60 is described first, and then a method of producing the protection structure 33 is described.

<2.1. Configuration of Mold>

The hardware configuration of the mold 60 is described below. The mold 60 heats and pressurizes nonwoven fabrics 41a and 41b (see FIGS. 6 and 7) so as to mold the nonwoven fabrics 41a and 41b into the fixing structure 33 having a desired shape. With reference to FIG. 4, the mold 60 mainly includes a holder 61, the support plate 62, a compressor 63, and heaters 64 (64a and 64b).

The holder 61 is a holding component holding the support plate 62. As shown in FIG. 4, the heater 64a is embedded in the holder 61. A holding space 61a is a recess formed on an upper side (Z-axis plus side: support plate 62 side) of the holder 61 and faces an upper surface 61b of the holder 61.

The support plate 62 is held by the holder 61 in a state of being fitted in the holding space 61a. As shown in FIG. 4, the support plate 62 mainly includes a frame 62a and a die 62b.

In cooperation with a punch 63b of the compressor 63, the die 62b performs a punching operation on the fixing portion 43. For example, in a case where the fixing structure 33 is produced by the mold 60, the punch 63b of the compressor 63 is inserted to an insertion hole 62c that passes through the die 62b (see FIG. 7), thereby forming the retaining hole 43b (see FIGS. 2 and 3).

As shown in FIGS. 6 and 7, the frame 62a supports the nonwoven fabrics 41a and 41b, which are objects of heating and pressurization. As shown in FIG. 4, a lower surface 62d of the frame 62a is formed along the shape of the holding space 61a of the holder 61. Specifically, the upper surface 61b of the holder 61 and the lower surface 62d of the frame 62a have substantially the same shape. Accordingly, the support plate 62 has good engagement with the holding space 61a of the holder 61.

Furthermore, a punch insertion space 62g and a protector formation space 62h are provided to a portion on an upper side of the frame 62a (Z-axis plus side: compressor 63 side) excluding a flat portion 62e.

The punch insertion space 62g is a recess provided on the upper side of the frame 62a. As shown in FIG. 5, an upper side of the punch insertion space 62g can be closed by the die 62b. Accordingly, when a punching operation is performed by the die 62b and the punch 63b of the compressor 63, the punched-out nonwoven fabrics 41a and 41b are collected in the punch insertion space 62g.

The protector formation space 62h is a recess provided on the upper side of the frame 62a, similar to the punch insertion space 62g. When the fixing structure 33 is produced by the mold 60, the nonwoven fabrics 41a and 41b in proximity of the protector formation space 62h, the main wire 20, and the branch wire 30 are housed in the interior of the protector formation space 62h due to pressure from a base 63a of the compressor 63. Thereby, the protector 42 is formed so as to surround a portion of the main wire 20 and the branch wire 30.

The compressor 63 is a pressurizing component that applies pressure to the nonwoven fabrics 41a and 41b provided between the compressor 63 and the support plate 62. The compressor 63 mainly includes the base 63a, the punch 63b, and a projection 63c, as shown in FIG. 4.

The base 63a is a substantially rectangular parallelepiped block. As shown in FIG. 4, the heater 64b is embedded in the base 63a. The punch 63b is a block having a substantially rectangular shape (square or rectangle) in a side view, and projects downward (to Z-axis minus side: support plate 62 side) from the base 63a. The projection 63c is a projection having a semicircular shape in a side view and extends along the Y-axis direction.

When the compressor 63 descends relative to the support plate 62, the nonwoven fabrics 41a and 41b are pressurized (see FIG. 7). For example, with the nonwoven fabrics 41a and 41b being compressed by a flat lower surface 63d of the base 63a and the flat portion 62e and a flat portion 62j of the support plate 62, the flat surface 42a of the protector 42 and the flat surface 43a of the fixing portion 43 are each formed.

Furthermore, with the nonwoven fabrics 41a and 41b being punched out by the insertion hole 62c of the support plate 62 and the punch 63b of the compressor 63, the retaining hole 43b of the fixing portion 43 is formed. Moreover, with the nonwoven fabrics 41a and 41b being compressed by the flat portion 62e of the support plate 62 and the projection 63c of the compressor 63, the groove 43c of the fixing portion 43 is formed.

The heaters 64 (64a and 64b) are heating components that heat the nonwoven fabrics 41 (41a and 41b) (see FIGS. 6 and 7). The heaters 64a and 64b are embedded in a bottom 61c of the holder 61 and the base 63a of the compressor 63, respectively, as shown in FIG. 4.

With the heater 64a driven, the holder 61 increases in temperature and mainly heats the nonwoven fabric 41a. On the other hand, with the heater 64b driven, the compressor 63 increases in temperature and mainly heats the nonwoven fabric 41b (see FIGS. 6 and 7).

A controller 90 performs, for example, control of heating by the heaters 64 (64a and 64b), data calculation, and the like. As shown in FIG. 4, the controller 90 mainly includes a ROM 91, a RAM 92, and a CPU 93. The controller 90 is electrically connected to the components of the mold 60 (e.g., the heaters 64 (64a and 64b)) through signal lines 99, as shown in FIG. 4.

The ROM (Read Only Memory) 91 is a so-called nonvolatile memory and stores a program 91a, for example. The ROM 91 may be a flash memory, which is a readable and writable nonvolatile memory.

The RAM (Random Access Memory) 92 is a volatile memory and stores data used in calculation by the CPU 93, for example. The CPU (Central Processing Unit) 93 executes control based on the program 91a of the ROM 91 (e.g., control of heating to the nonwoven fabrics 41a and 41b), data calculation, and the like.

<2.2. Method of Producing Fixing Structure Using Mold>

A method of producing the fixing structure 33 using the mold 60 is described below with reference to FIGS. 6 and 7.

First, between the support plate 62 and the compressor 63, the nonwoven fabric 41a, the main wire 20 and the branch wire 30, and the nonwoven fabric 41b are provided in this order from above.

Subsequently, with the compressor 63 descending relative to the support plate 62, the nonwoven fabrics 41a and 41b are pressurized. Thereby, a portion of the nonwoven fabrics 41 a and 41b is housed in the protector formation space 62h (see FIG. 7). Another portion of the nonwoven fabrics 41a and 41b is compressed between the flat portion 62e and the projection 63c (see FIGS. 6 and 7). In addition, yet another portion of the nonwoven fabrics 41a and 41b is punched out by the insertion hole 62c of the die 62b and the punch 63b (see FIGS. 6 and 7).

Further, while pressurizing process is performed by the compressor 63, the heater 64a of the holder 61 and the heater 64b of the compressor 63 are driven by the controller 90. Accordingly, the nonwoven fabrics 41a and 41b are heated at a temperature equal to or higher than the melting point of the binder material (second temperature) and lower than the melting point of the base material (first temperature).

Subsequently, the heating by the heaters 64 (64a and 64b) are stopped. The fixing structure 33 is then cooled by air and the like. Accordingly, a portion or all of the binder material in a joint portion 49 is melt and spread into the base, and is then cooled and solidified. Thus, the protector 42 and the fixing portion 43 are joined at each joint portion 49, thereby completing formation of the fixing structure 33.

<3. Advantages of Fixing Structure of Present Embodiment>

As described above, in the fixing structure 33 of the present embodiment, the protector 42 protects a portion of the electric wires 22 and 32. The fixing portion 43, which is integrally formed with the protector 42, fixates the connector 35 provided at the one end 30a of the electric wire 32.

Accordingly, separate work (e.g., wrapping) to fixate the connector 35 becomes unnecessary. When the connector 35 is fixated by the fixing portion 43, the electric wire 32 protected by the protector 42 is not routed for unnecessary extension. This minimizes work man-hours required for wiring the electric wire 32 and fixating the connector 35, thus curtailing the production cost of the wire harness 10.

<4. Modification>

The embodiment of the present invention was described above. The present invention, however, is not limited to the embodiment above and may be modified in various ways.

(1) In the present embodiment, one retaining hole 43b is provided to the fixing portion 43. However, a number of the retaining hole 43b is not limited to one, and may be two or more (plural), for example. In this case, the fixing portion 43 can fixate a plurality of connectors 35.

(2) In the present embodiment, the fixing portion 43 can be bent at the groove 43c. However, processing technique at the groove 43c is not limited to the technique above. For example, in a case where the connector 35 does not need to be fixated, the fixing portion 43 may be cut along the groove 43c and be separated from the protector 42. In this case, space saving in a vicinity of the protector 42 becomes possible.

### REFERENCE SIGNS LIST

10: Wire harness
20: Main wire
22, 32: Electric wire
25, 35: Connector
30: Branch wire
30a: One end
33: Fixing structure
41 (41a and 41b): Nonwoven fabric
42: Protector
43: Fixing portion
43b: Retaining hole
43c: Groove
49: Joint portion
60: Mold
61: Holder
62: Support plate
63: Compressor
64 (64a and 64b): Heater
90: Controller

1. A connector fixing structure, comprising:
(a) a connector provided at one end of an electric wire;
(b) a protector surrounding a portion of the electric wire; and
(c) a fixing portion integrally formed with the protector and fixating the connector, wherein
the protector and the fixing portion are formed of a protection material that comprises a base material and a binder material having a melting point lower than that of the base material; and
the protector and the fixing portion are joined at each joint portion by cooling and solidifying the melted binder material.

2. The connector fixing structure according to claim 1, wherein the fixing portion is provided with a groove adjacent to a boundary between the fixing portion and the protector.

3. The connector fixing structure according to claim 1, wherein the connector is retained by a retaining hole provided to the fixing portion.
